(19) United States
(12) Patent Application Publication
(10) Pub. No.: US 2020/0117974 A1
(43) Pub. Date: Apr. 16, 2020

(54) ROBOT WITH MULTIPLE PERSONAE BASED ON INTERCHANGEABILITY OF A ROBOTIC SHELL THEREOF

(71) Applicant: Mike Rizkalla, New York City, NY (US)

(72) Inventor: Mike Rizkalla, New York City, NY (US)

(21) Appl. No.: 16/597,862

(22) Filed: Oct. 10, 2019

Related U.S. Application Data
(60) Provisional application No. 62/743,556, filed on Oct. 10, 2018.
(60) Provisional application No. 62/774,343, filed on Dec. 3, 2018.

(51) Int. Cl. G06N 3/00; G06N 20/00; G06N 5/04

(52) U.S. Cl. CPC G06N 3/008; G06N 5/04; G06N 20/00

(57) ABSTRACT

A method includes providing a base mechanism including circuitry associated with core functionalities relevant to a robot, and configuring each robotic shell of a number of robotic shells with data related to a specific set of functionalities associated with a specific persona. The method also includes providing a capability to automatically customize the robot for each of the specific personae associated with the configured number of robotic shells based on removably coupling the configured corresponding robotic shell to the base mechanism such that the resulting robot is capable of performing the specific set of functionalities associated with the each of the specific personae.

### CLAIM OF PRIORITY

This application is a conversion application of U.S. Provisional Application No. 62/743,556 titled INTERCHANGEABLE ROBOTIC SHELL TO INITIATE DIFFERENTIATED PERSONALITY CHARACTERISTICS TO A ROBOTIC BASE filed on Oct. 10, 2018 and U.S. Provisional Application No. 62/774,343 titled ROBOTIC INTERACTION WITH VIRTUAL ELEMENTS METHOD AND SYSTEM filed on Dec. 3, 2018. The contents of the aforementioned applications are incorporated by reference in entirety thereof.

### FIELD OF TECHNOLOGY

This disclosure relates generally to robotics and, more particularly, to a method, a device and/or a system of a robot with multiple personae based on interchangeability of a robotic shell thereof.

### BACKGROUND

A robot may be a machine integrated with various technologies based on mechanics, electronics, software, sensing and/or control. The robot may be capable of performing complex operations in scenarios involving but not limited to shopping, entertainment, gaming and logistics. The robot may, therefore, be bulky and expensive. Moreover, the robot may not have applicability across multiple avenues.

### SUMMARY

Disclosed are a method, a device and/or a system of a robot with multiple personae based on interchangeability of a robotic shell thereof.

In one aspect, a method includes providing a base mechanism including circuitry associated with core functionalities relevant to a robot, and configuring each robotic shell of a number of robotic shells with data related to a specific set of functionalities associated with a specific persona. The method also includes providing a capability to automatically customize the robot for each of the specific personae associated with the configured number of robotic shells based on removably coupling the configured corresponding robotic shell to the base mechanism such that the resulting robot is capable of performing the specific set of functionalities associated with the each of the specific personae.

In another aspect, a robot includes a base mechanism including circuitry associated with core functionalities relevant to a robot, and a number of robotic shells, each of which is configured with data related to a specific set of functionalities associated with a specific persona. The robot is automatically customizable for each of the specific personae associated with the configured number of robotic shells based on removable coupling of the configured corresponding robotic shell to the base mechanism such that the resulting robot is capable of performing the specific set of functionalities associated with the each of the specific personae through a processor associated with the base mechanism and/or the configured corresponding robotic shell.

In yet another aspect, a system includes a base mechanism including circuitry associated with core functionalities relevant to a robot, and a data processing device configured to configure each robotic shell of a number of robotic shells with data related to a specific set of functionalities associated with a specific persona. The robot is automatically customizable for each of the specific personae associated with the configured number of robotic shells based on removable coupling of the configured corresponding robotic shell to the base mechanism such that the resulting robot is capable of performing the specific set of functionalities associated with the each of the specific personae through a processor associated with the base mechanism and/or the configured corresponding robotic shell.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a robotic system, according to one or more embodiments.

FIG. 2 is an illustrative view of a robot of the robotic system of FIG. 1, according to one or more embodiments.

FIG. 3 is a schematic view of a robotic shell and a base mechanism of the robot of the robotic system of FIG. 1, according to one or more embodiments.

FIG. 4 is a schematic view of multiple robots, each of which is analogous to the robot of FIG. 1-3, coupled to one another through a computer network, according to one or more embodiments.

FIG. 5 is a schematic view of a capability of plugging in multiple robotic shells into the base mechanism of the robot of FIGS. 1-3, according to one or more embodiments.

FIG. 6 is a process flow diagram detailing the operations involved in providing a robot with multiple personae based on interchangeability of a robotic shell thereof, according to one or more embodiments.

Other features of the present embodiments will be apparent from the accompanying drawings and from the detailed description that follows.

### DETAILED DESCRIPTION

Example embodiments, as described below, may be used to provide a robot with multiple personae based on interchangeability of a robotic shell thereof. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

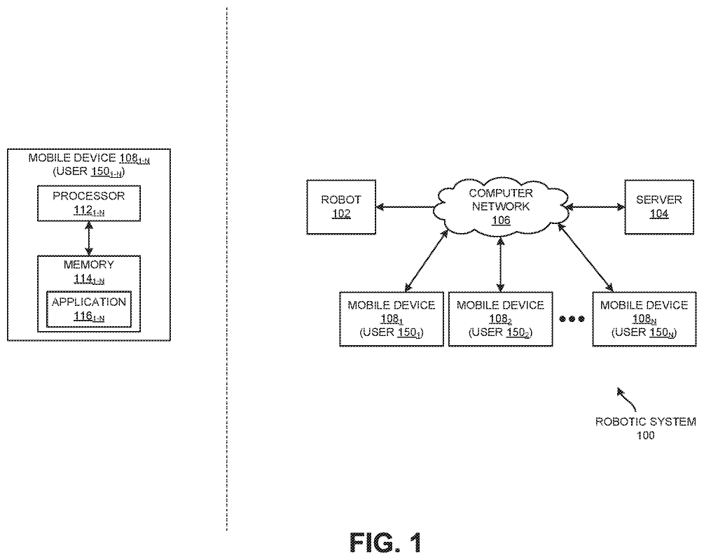

FIG. 1 shows a robotic system 100, according to one or more embodiments. In one or more embodiments, robotic system 100 may include a robot 102 communicatively coupled to a server 104 through a computer network 106. In one or more embodiments, robot 102 may be configured to perform a variety of functions including virtual interaction with a number of mobile devices 108_{1-N} (e.g., mobile phones, tablets, smart devices such as smart watches, portable media players) communicatively coupled thereto through computer network 106. Computer network 106, as discussed herein, may refer to but is not limited to a variety of long-range and/or short-range (e.g., including near-field communication based networks) computer networks such as a Wide Area Network (WAN), a Local Area Network (LAN), a mobile communication network, WiFi™, and Bluetooth®. Contextual applicability may be implied by the use of the term “computer network” with respect to computer network 106.

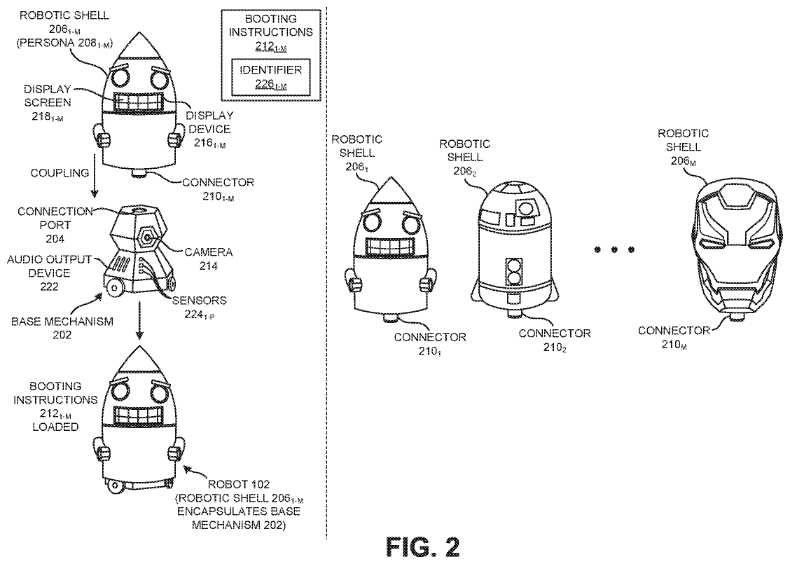

For example, computer network 106 may refer to Bluetooth® or mobile Internet when one or more device(s) 108_{1-N} interact with robot 102. In another example, a WAN and/or a LAN may be employed for communication between server 104 and robot 102. FIG. 2 shows robot 102, according to one or more embodiments. In one or more embodiments, robot 102 may include a base mechanism 202 having a connection port 204 thereon configured to connect a number of robotic shells 206_{1-M} to base mechanism 202. In one or more embodiments, each robotic shell 206_{1-M} may be associated with a persona 208_{1-M} of robot 102. In other words, the connection of a robotic shell 206_{1-M} to base mechanism 202 by way of connection port 204 may provide a unique persona 208_{1-M} to robot 102.

In one or more embodiments, robot 102 may be an intelligent machine designed to physically and/or characteristically resemble each of multiple personae 208_{1-M}, and perform complex actions and/or operations associated with each of multiple personae 208_{1-M}. In one or more embodiments, one or more personae 208_{1-M} may require robot 102 to virtually interact with the number of mobile devices 108_{1-N} to realize multiple scenarios (e.g., a gaming scenario).

FIG. 2 shows a robotic shell 206_{1-M} having a connector 210_{1-M} configured to be plugged into connection port 204 to configure robot 102 for a specific persona 208_{1-M}, according to one or more embodiments. As discussed above, in one or more embodiments, robot 102 may be activated to perform operations associated with a specific persona 208_{1-M} relevant to a corresponding robotic shell 206_{1-M} based on plugging robotic shell 206_{1-M} onto base mechanism 202. In one or more alternate implementations, robotic shell 206_{1-M} may be configured to receive base mechanism 202 therein instead of connector 210_{1-M} of robotic shell 206_{1-M} being received into connection port 204 of base mechanism 202.

In the abovementioned modification, robotic shell 206_{1-M} may have an analogous connection port 204 and base mechanism 202 may have an analogous connector 210_{1-M}. Thus, it should be noted that exemplary embodiments may not be limited to configurations depicted in the figures. Reasonable modifications thereof are within the scope of the exemplary embodiments discussed herein. In one example implementation, the connection of a robotic shell 206_{1-M} with base mechanism 202 may automatically load booting instructions 212_{1-M} onto base mechanism 202 to enable activation of the corresponding persona 208_{1-M}.

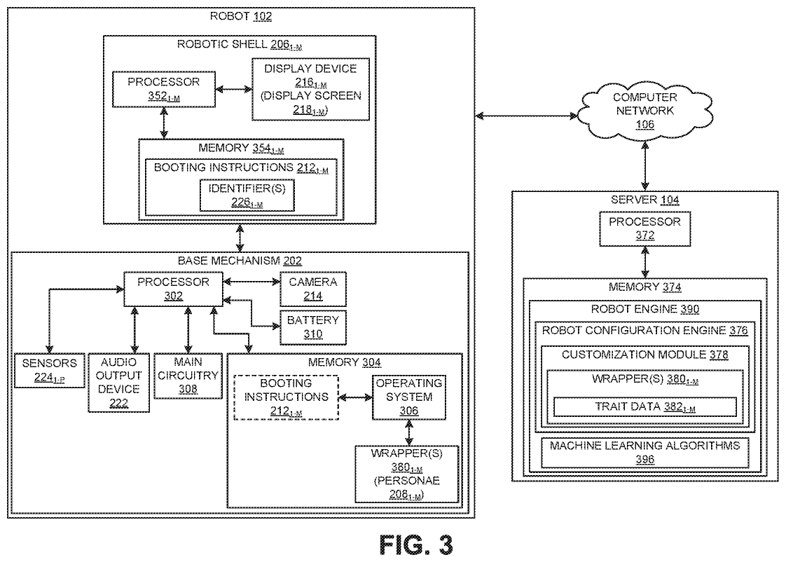

FIG. 3 shows a block diagram of a robotic shell 206_{1-M} and base mechanism 202, according to one or more embodiments. In one or more embodiments, base mechanism 202 may include a processor 302 (e.g., a microprocessor) communicatively coupled to a memory 304 (e.g., a volatile and/or a non-volatile memory). Similarly, in one or more embodiments, robotic shell 206_{1-M} may include a processor 352_{1-M} (e.g., a microprocessor) communicatively coupled to a memory 354_{1-M}. In one or more embodiments, memory 354_{1-M} may include booting instructions 212_{1-M} configured to be loaded onto memory 304 through processor 352_{1-M} following the connection of robotic shell 206_{1-M} to base mechanism 202. In one or more embodiments, processor 302 may then begin execution of booting instructions 212_{1-M}.

In another implementation, processor 302 may execute a set of instructions to access memory 354_{1-M} of robotic shell 206_{1-M}, and load booting instructions 212_{1-M} onto memory 304 associated therewith. In yet another implementation, the powering of robot 102 based on connecting robotic shell 206_{1-M} to base mechanism 202 may be followed by loading of booting instructions 212_{1-M} onto memory 304 through a mobile device 108_{1-N} (e.g., wirelessly through short-range computer network 106). All reasonable variations are within the scope of the exemplary embodiments discussed herein.

In one or more embodiments, the execution of booting instructions 212_{1-M} on processor 302 may load an operating system 306 onto memory 304; said operating system 306 may be customized for operations and/or actions associated with the relevant persona 208_{1-M} associated with the robotic shell 206_{1-M} connected to base mechanism 202. In one implementation, the customization of operating system 306 may occur right after execution of booting instructions 212_{1-M} based on each robotic shell 206_{1-M} having a customized set of booting instructions 212_{1-M} associated therewith. FIG. 3 also shows server 104 communicatively coupled to robot 102 by way of computer network 106. In one or more embodiments, server 104 may include a processor 372 (e.g., a microprocessor, a cluster of processors) communicatively coupled to memory 374 (e.g., a volatile and/or a non-volatile memory).

In one or more embodiments, memory 374 of server 104 may include a robot configuration engine 376 (e.g., including sets of instructions) executing thereon; said robot configuration engine 376 may, in turn, include a customization module 378 responsible for customization of operating system 306 for each robotic shell 206_{1-M} and associated persona 208_{1-M}. In one or more embodiments, customization module 378 may include a number of wrapper(s) 380_{1-M} configured to wrap around Application Programming Interface(s) (APIs) of operating system 306; each wrapper 380_{1-M} may be specific to a robotic shell 206_{1-M} and associated persona 208_{1-M}. Thus, in an alternate implementation, the customization of operating system 306 may occur automatically after the loading thereof onto memory 304 based on a wrapper 380_{1-M} specific to robotic shell 206_{1-M} automatically wrapping around (e.g., around APIs of operating system 306) operating system 306.

In one or more embodiments, robot 102 may acquire a specific persona 208_{1-M} after the relevant wrapper 380_{1-M} wraps around operating system 306. In one or more other embodiments, the specific persona 208_{1-M} may be acquired as soon as booting instructions 212_{1-M} are loaded onto memory 304 and executed through processor 302, without the need for a wrapper 380_{1-M}. Here, persona 208_{1-M} and associated trait data 382_{1-M} (e.g., data related to capabilities and functionalities associated with persona 208_{1-M}) may be refined based on updates from server 104. FIG. 3 shows associated trait data 382_{1-M} as being part of wrapper(s) 380_{1-M}. Said wrapper(s) 380_{1-M} are shown as part of both memory 304 and memory 374. Further, in some other embodiments, the connection of robotic shell 206_{1-M} to base mechanism 202 may be sufficient to execute booting instructions 212_{1-M} directly through processor 352_{1-M} to customize robot 102 for a specific persona 208_{1-M}. All reasonable variations are within the scope of the exemplary embodiments discussed herein.

In one or more embodiments, base mechanism 202 may include main circuitry for functioning of robot 102. FIG. 3 shows main circuitry 308 as interfaced with (and, thereby, controlled by) processor 302. In one or more embodiments, main circuitry 308 along with booting instructions 212_{1-M} and a relevant wrapper 380_{1-M} may help assemble and activate robot 102 when a robotic shell 206_{1-M} is plugged into base mechanism 202. In one or more embodiments, main circuitry 308 may be powered by the plugging in of the aforementioned robotic shell 206_{1-M} into base mechanism 202. For example, the plugging in of the robotic shell 206_{1-M} into base mechanism 202 may provide electrical paths for a battery 310 (e.g., rechargeable) of base mechanism 202 to power main circuitry 308.

Alternately, base mechanism 202, and, thereby, robot 102, may be powered through a power converter/adapter (not shown) that takes power directly from the mains and performs conversion thereof into levels compatible with components of robot 102 including those of base mechanism 202 and robotic shells 206_{1-M}. It should be noted that while preferentially battery 310 may solely be part of base mechanism 202, it is possible to envision one or more batteries that are part of robotic shells 206_{1-M} configured to power components thereof; in certain embodiments, robot 102 including base mechanism 202 and main circuitry 308 thereof may be completely powered based on the one or more batteries of robotic shells 206_{1-M}. All reasonable variations are within the scope of the exemplary embodiments discussed herein.

In one or more embodiments, base mechanism 202 may be fully enclosed under robotic shell 206_{1-M} following plugging thereof. In alternate embodiments, base mechanism 202 may merely be received within robotic shell 206_{1-M}, which is encapsulated by base mechanism 202. It should be noted that functionalities associated with robot 102 may dictate designs of base mechanism 202 and/or robotic shells 206_{1-M}.

Referring back to FIG. 2, in one or more embodiments, base mechanism 202 may also include a camera 214 (or, to generalize, image sensor; camera 214 is also shown in FIG. 3) configured to capture images and/or video frames of an environment surrounding robot 102. Further, in one or more embodiments, camera 214 may help determine position and/or orientation of objects in the aforementioned environment. FIG. 3 shows camera 214 interfaced with processor 302. In scenarios/applications involving interaction with mobile devices 108_{1-N}, camera 214 may transmit captured images and/or video frames thereto.

In one or more embodiments, the connection (e.g., based on connector 210_{1-M} and connection port 204) between robotic shell 206_{1-M} and base mechanism 202 may enable data transmission therebetween. In one or more embodiments, the aforementioned connection may be based on a Universal Serial Bus (USB) communication, serial communication and/or a circular interface. In one or more embodiments, connection port 204 may be designed such that a length of the structure thereof may act an axis of rotation of robotic shell 206_{1-M} for one or more functionalities associated with a corresponding persona 208_{1-M}.

In one or more embodiments, robotic shell 206_{1-M} may also include a display device 216_{1-M} configured to display messages and/or visual effects through a display screen 218_{1-M} thereof. In one example implementation, display device 216_{1-M} may be embedded within robotic shell 206_{1-M} such that display screen 218_{1-M} may be located on an external surface thereof. In one or more embodiments, display device 216_{1-M} may be a Light Emitting Diode (LED) display or a Liquid Crystal Display (LCD). Other forms of display device 216_{1-M} are within the scope of the embodiments discussed herein. Also, it is possible to envision display device 216_{1-M} as a uniform external device configured to be interfaced with robotic shell 206_{1-M}. Further, it is obvious that location of display screen 218_{1-M}, position of display screen 218_{1-M} and/or type of display device 216_{1-M} may be selected based on design and/or application considerations.

It should be noted that, instead of or in addition to robotic shell 206_{1-M}, base mechanism 202 may include one or more display device(s) and/or display screen(s) (not shown). For example, said display device(s) may display content applicable across robotic shells 206_{1-M}. In one or more embodiments, base mechanism 202 may include a projector device (not shown) configured to project stored (e.g., in memory 304 and/or memory 374), captured (e.g., through camera 214) and/or network-available (e.g., through computer network 106) data (e.g., videos/images) onto a target surface (e.g., a wall, a screen). In some embodiments, the aforementioned projection may be monitored and/or controlled through one or more mobile device(s) 108_{1-N}.

In one or more embodiments, base mechanism 202 may also include an audio output device 222 (e.g., a speaker) to output audio relevant to functionalities and/or operations associated with persona 208_{1-M}. In addition thereto, in one or more embodiments, audio output device 222 may output audio common to all robotic shells 206_{1-M} (or, personae 208_{1-M}) such as instructions to users 150_{1-N} at corresponding mobile devices 108_{1-N} (refer to FIG. 1). It is obvious that each robotic shell 206_{1-M}, in turn, may include one or more audio output device(s) (e.g., speakers) to perform unique operations associated therewith. All reasonable variations are within the scope of the exemplary embodiments discussed herein.

In one or more embodiments, base mechanism 202 may further include a number of sensor(s) 224_{1-P} configured to provide a plethora of inputs to processor 302 and/or processor 372 to enable realization of functionalities and/or execution of operations associated with personae 208_{1-M}. FIG. 1 also shows each mobile device 108_{1-N} as including a processor 112_{1-N} communicatively coupled to a memory 114_{1-N}, according to one or more embodiments. In one or more embodiments, one or more of sensor(s) 224_{1-P} may also provide real-time information to one or more mobile devices 108_{1-N} to enable reactions and/or responses thereto.

In one or more embodiments, based on inputs to processor 302 and/or processor 372 (of server 104), a robot engine 390 executing on processor 372 (robot engine 390 may include robot configuration engine 376, as shown in FIG. 3) may adapt and/or update wrappers 380_{1-M} and or provide additional capabilities and/or improvements to a current robotic shell 206_{1-M} (or, a current persona 208_{1-M}) functioning in tandem with base mechanism 202 as robot 102. Obviously, in one or more embodiments, data from sensors 224_{1-P} may improve an awareness of robot 102 with respect to the environment thereof. Additionally, in one or more embodiments, contextual awareness of robot 102 with respect to functionalities and/or operations relevant to personae 208_{1-M} may be improved.

In one or more embodiments, machine learning algorithms 396 (refer to FIG. 3) may be implemented at server 104 through robot engine 390. The inputs from sensor(s) 224_{1-P} and/or mobile devices 108_{1-N} (e.g., through users 150_{1-N} thereof) may train the aforementioned machine learning algorithms 396 in order to further enhance predictive and/or operative capabilities of robot 102 with respect to each and every robotic shell 206_{1-M} and associated personae 208_{1-M}. In one or more embodiments, the number of sensor(s) 224_{1-P} may include but are not limited to one or more of: a collision detection sensor, a light sensor, an audio sensor, a temperature sensor, a proximity sensor, a contact sensor, a distance sensor, a pressure sensor, a tilt sensor, a navigation/position sensor, and an acceleration sensor.

In one or more embodiments, sensors 224_{1-P} and audio output device 222 may be interfaced with processor 302, as shown in FIG. 3, akin to camera 214. In one or more embodiments, booting instructions 212_{1-M} associated with each robotic shell 206_{1-M} may include an identifier 226_{1-M} associated therewith, which identifies functionalities and/or operations associated with the relevant persona 208_{1-M}. In one or more embodiments, said identifier 226_{1-M} may, in turn, be a set of instructions configured to trigger wrapping of the relevant wrapper 380_{1-M} around operating system 306 to customize robot 102 for a specific robotic shell 206_{1-M}. In one or more other embodiments, memory 304 may include booting instructions 212_{1-M} relevant to all robotic shells 206_{1-M}. Upon connecting a specific robotic shell 206_{1-M} to base mechanism 202, booting instructions 212_{1-M} relevant to the specific robotic shell 206_{1-M} may be identified based on identifier 226_{1-M} and executed on processor 302 to load operating system 306. In one or more embodiments, the relevant wrapper 380_{1-M} may subsequently be wrapped around operating system 306. All reasonable variations are within the scope of the exemplary embodiments discussed herein.

Referring back to FIG. 1, memory 114_{1-N} of each mobile device 108_{1-N} may include an application 116_{1-N}, associated with one or more robotic shells 206_{1-M} and configured to execute on processor 112_{1-N}, according to one or more embodiments. In one or more embodiments, said application 116_{1-N} may allow a user 150_{1-N} of a mobile device 108_{1-N} to configure robot 102 based on one or more robotic shells 206_{1-M} and/or control robot 102 based on inputs therefrom. In one example embodiment, a real-time multi-player gaming experience may be enabled for a number of users 150_{1-N} at corresponding mobile devices 108_{1-N} through robot 102 (and the associated robotic shell(s) 206_{1-M}). In one or more embodiments, additional experiences provided through robot 102 may include augmented reality, mixed reality and/or virtual reality based experiences in tandem with mobile devices 108_{1-N}. In one or more embodiments, robot 102 may continuously respond to an ongoing sequence of activities (e.g., gaming related) in real-time based on the current persona 208_{1-M} thereof.

In one or more embodiments, a robotic shell 206_{1-M} may also serve as an external protective case of robot 102 while performing functions, operations and/or tasks relevant to the current persona 208_{1-M}. As implied above, base mechanism 202 may instead serve as the external protective case of robot 102 in embodiments where robotic shell 206_{1-M} is received therewithin. In one or more embodiments, each robotic shell 206_{1-M} may be hollow in an inside thereof to fully enclose and/or encompass base mechanism 202 therewithin.

In one or more embodiments, personae 208_{1-M} associated with robotic shells 206_{1-M} may represent different robotic character(s). Examples of personae 208_{1-M} may include but are not limited to a superhero, a living personality, a dead personality, a fictional character (e.g., a cartoon character) and an animal. As discussed above, in one or more embodiments, each personae 208_{1-M} may have a unique identifier 226_{1-M} associated therewith. Additionally, in one or more embodiments, an external and physical appearance of each robotic shell 206_{1-M} may be designed according to the corresponding persona 208_{1-M}.

In one or more embodiments, trait data 382_{1-M} associated with each persona 208_{1-M} (and, corresponding wrapper 380_{1-M}) may include but are not limited to virtual manifestation data, audio data, accent data, dialogue data and/or virtual effects data. In one or more embodiments, a persona 208_{1-M} may be unique for a corresponding robotic shell 206_{1-M}. In one or more embodiments, said trait data 382_{1-M} may be configured and/or reconfigured by an authorized user 150_{1-N} (e.g., at a corresponding mobile device 108_{1-N}). While FIG. 1 shows mobile devices 108_{1-N} configured to interact with robot 102, it should be noted that the aforementioned devices may be generalized as data processing devices. For example, trait data 382_{1-M} may be configured through one or more data processing device(s) (e.g., laptops, desktop computers, servers) communicatively coupled to robot 102 through computer network 106 instead of one or more mobile device(s) 108_{1-N}. In another example, the authorized user 150_{1-N} may create a new persona 208_{1-M} for a corresponding robotic shell 206_{1-M}.

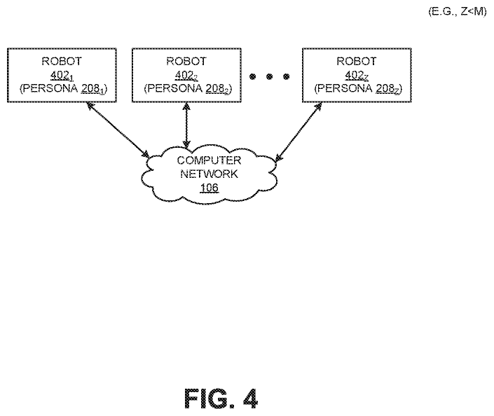

FIG. 4 shows multiple robots 402_{1-Z} coupled to one another through computer network 106, according to one or more embodiments. In one or more embodiments, each robot 402_{1-Z} may be a robot analogous to robot 102. In one example scenario, robots 402_{1-Z} may all be in one specific geographical area or geographical location. One robot 402₁ may have acquired a persona, say persona 208₁ associated with robotic shell 206₁, and another robot 402₂ may have acquired persona 208₂ associated with robotic shell 206₂ and so on. The aforementioned robots 402_{1-Z} may, thus, be capable of working in tandem with one another toward specific ends. For example, robots 402_{1-Z} may play a game with one another.

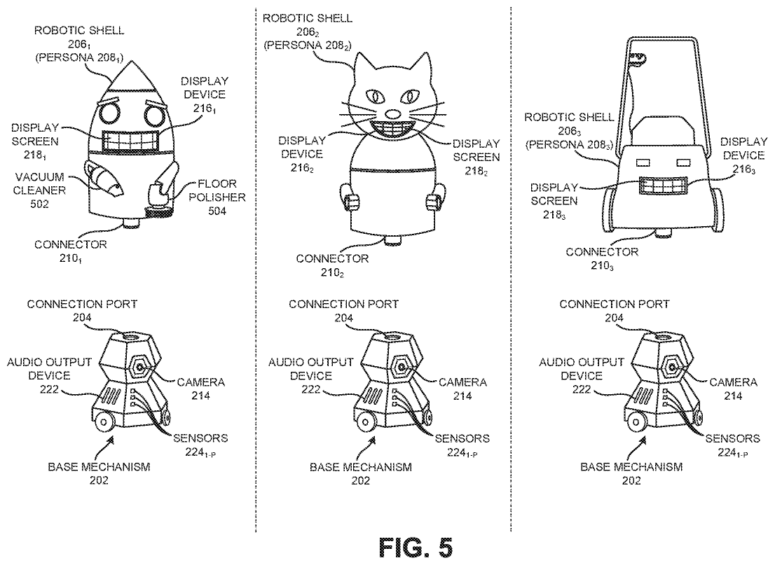

FIG. 5 demonstrates the capability of plugging in three robotic shells 206₁₋₃ into base mechanism 202, according to one or more embodiments. In one example embodiment, robot 102 may be a housekeeper robot. Here, the associated robotic shell 206₁ representing a housekeeper character may be plugged into base mechanism 202 to enable robot 102 acquire persona 208₁, i.e., that of a housekeeper. In this example embodiment, robotic shell 206₁ may be equipped with (or, coupled to) a vacuum cleaner 502. A user 150₁ at a corresponding mobile device 108₁ may control the housekeeper robot 102 to clean a specific area.

In addition, robotic shell 206₁ of the housekeeper robot 102 may also be equipped with (or, coupled to) a floor polisher 504. Here, user 150₁ may plot a course for the housekeeper robot 102 with floor polisher 504 to polish through mobile device 108₁. In another example embodiment, robot 102 may function as a toy for a pet of a user 150₂. Again, robotic shell 206₂ representing the toy may be plugged into base mechanism 202 to enable robot 102 to acquire persona 208₂ associated with the toy. Based on control through a mobile device 108₂, user 150₂ may enable a pet thereof to play with robot 102 for entertainment and/or exercise purposes.

In yet another example embodiment, robot 102 may function as a lawnmower robot based on a robotic shell 206₃ representing persona 208₃ of a lawnmower being plugged into base mechanism 202. Specific areas to be moved on the lawn may be specified (or, computed) by a user 150₃ through a corresponding mobile device 108₃.

It is quite easy to envision robot 102 being a pet robot based on acquisition of persona 208_{1-M} associated with a pet. Here, a user 150_{1-N} may interact with robot 102 that represents a pet through a mobile device 108_{1-N} thereof in an environment simulating reality. Example interactions may include but are not limited to throwing a virtual ball, virtual feeding, training robot 102 and/or commanding robot 102. It is obvious that robot 102 may be configured to appropriately respond to the aforementioned example interactions.

Other example applications of robot 102 may lie in education (e.g., training a user 150_{1-N} at a mobile device 108_{1-N} to learn mathematics and/or computer programming), disc jockeying (DEng; e.g., a corresponding robotic shell 206_{1-M} may have mirrors and/or LED lights to project onto a ceiling and/or a wall associated therewith; robot 102 may play selected tunes from a music library through audio output device 222 and/or through a mobile device 108_{1-N} of a corresponding user 150_{1-N}), and security services (e.g., robotic shell 206_{1-M} may take persona 208_{1-M} and a form of a security guard; a user 150_{1-N} at a corresponding mobile device 108_{1-N} may configure movement of robot 102 within a predetermined area; sensors 224_{1-P} may monitor the predetermined area and may trigger alarms based on detection of the presence of an intruder).

Still further, robot 102 may acquire persona 208_{1-M} of a supply chain worker based on design of an appropriate robotic shell 206_{1-M}. Here, the corresponding robotic shell 206_{1-M} may be equipped with one or more gripper(s) to pick up and/or move items within a warehouse. Obviously, the aforementioned movement and configuration may be performed through one or more mobile device(s) 108_{1-N} by corresponding one or more user(s) 150_{1-N} thereof.

Other possibilities such as but not limited to a robot 102 waiting at banquets and/or restaurants based on augmented reality based interfaces and sensors 224_{1-P} to prevent collisions with obstacles and robot 102 serving as a shopping cart paired with mobile phones 108_{1-N} and employing the aforementioned augmented reality based interfaces are within the scope of the exemplary embodiments discussed herein.

Thus, exemplary embodiments provide for cost reduction with respect to manufacturing and/or configuring robot 102 with enhanced capabilities. In one or more embodiments, the modularization through employing robotic shells 206_{1-M} with specific personae 208_{1-M} may lead to compactness in design and reduction in replacement and/or modification costs associated with robot 102. A typical complicated robot may be bulkier and more expensive to manufacture and maintain. Exemplary embodiments provide for robots (e.g., robot 102) at affordable prices that may be compact enough to be stored easily. In addition, instructions discussed above (e.g., booting instructions 212_{1-M}, robot engine 390) may be tangibly embodied on a non-transitory medium (e.g., a Compact Disc (CD), a Digital Video Disc (DVD), a Blue-ray disc®, a hard disk/drive), readable through a data processing device (e.g., server 104, robot 102, base mechanism 202, robotic shells 206_{1-M} and/or mobile devices 108_{1-N}). All reasonable variations are within the scope of the exemplary embodiments discussed herein.

Last but not the least, the enhanced capabilities and possibilities through robot 102 may empower storytellers and brands (e.g., related to games, toys and entertainment) to envision radical changes in approaches to problem solving; said storytellers and brands may also thoroughly benefit from the scalability in design of robot 102 and ease of use thereof. Also, it is possible to envision robot 102 with wheels and associated paraphernalia.

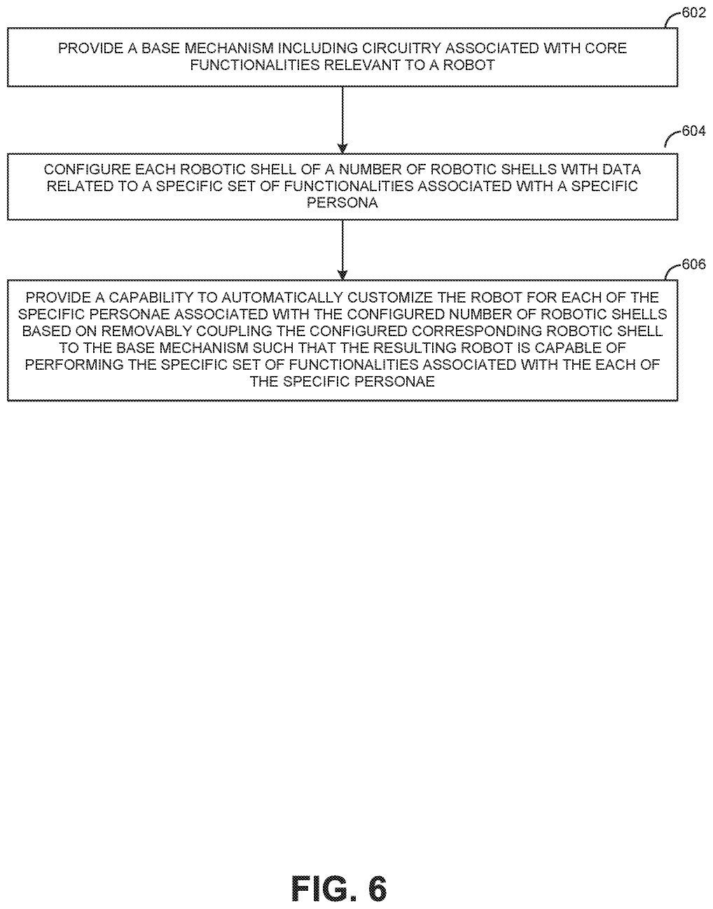

FIG. 6 shows a process flow diagram detailing the operations involved in providing a robot (e.g., robot 102) with multiple personae (e.g., personae 208_{1-M}) based on interchangeability of a robotic shell (e.g., robotic shell 206_{1-M}) thereof, according to one or more embodiments. In one or more embodiments, operation 602 may involve providing a base mechanism (e.g., base mechanism 202) including circuitry (e.g., main circuitry 308) associated with core functionalities relevant to the robot. In one or more embodiments, operation 604 may involve configuring each robotic shell of a number of robotic shells (e.g., robotic shells 206_{1-M}) with data (e.g., trait data 382_{1-M}) related to a specific set of functionalities associated with a specific persona. In one or more embodiments, operation 606 may then involve providing a capability to automatically customize the robot for each of the specific personae associated with the configured number of robotic shells based on removably coupling the configured corresponding robotic shell to the base mechanism such that the resulting robot is capable of performing the specific set of functionalities associated with the each of the specific personae.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., server 104, mobile devices 108_{1-N}, robot 102). Accordingly, the specification and drawings are to be regarded in an illustrative rather than a restrictive sense.

What is claimed is:

1. A method comprising:
providing a base mechanism comprising circuitry associated with core functionalities relevant to a robot;
configuring each robotic shell of a plurality of robotic shells with data related to a specific set of functionalities associated with a specific persona; and
providing a capability to automatically customize the robot for each of the specific personae associated with the configured plurality of robotic shells based on removably coupling the configured corresponding robotic shell to the base mechanism such that the resulting robot is capable of performing the specific set of functionalities associated with the each of the specific personae.

2. The method of claim 1, comprising the configured corresponding robotic shell encapsulating the base mechanism following the coupling therebetween.

3. The method of claim 1, wherein configuring the each robotic shell comprises configuring the each robotic shell through at least one of: an external server and an external data processing device.

4. The method of claim 1, wherein providing the capability to customize the robot for the each of the specific personae further comprises, in accordance with the coupling between the configured corresponding robotic shell and the base mechanism:
automatically executing instructions to load an operating system into at least one of: a first memory of the base mechanism and a second memory of the configured corresponding robotic shell to be executed on a corresponding at least one of: a first processor of the base mechanism and a second processor of the configured corresponding robotic shell; and
automatically wrapping the loaded operating system with a wrapper specific to the each of the specific personae to customize the robot for the each of the specific personae.

5. The method of claim 1, further comprising updating the specific set of functionalities associated with the each of the specific personae through at least one of: an external server and an external data processing device communicatively coupled to the resulting robot.

6. The method of claim 1, further comprising providing a capability to a plurality of data processing devices to interact with the resulting robot based on executing an appropriate application thereon.

7. The method of claim 1, further comprising enhancing at least one of: predictive and operative capabilities of the resulting robot based on executing, on a server communicatively coupled to the resulting robot, at least one machine learning algorithm that considers data from at least one sensor of the resulting robot as input thereto and is trained thereby.

8. A robot comprising:
a base mechanism comprising circuitry associated with core functionalities relevant to a robot; and
a plurality of robotic shells, each of which is configured with data related to a specific set of functionalities associated with a specific persona,
wherein the robot is automatically customizable for each of the specific personae associated with the configured plurality of robotic shells based on removable coupling of the configured corresponding robotic shell to the base mechanism such that the resulting robot is capable of performing the specific set of functionalities associated with the each of the specific personae through a processor associated with at least one of: the base mechanism and the configured corresponding robotic shell.

9. The robot of claim 8, wherein the configured corresponding robotic shell is capable of encapsulating the base mechanism following the coupling therebetween.

10. The robot of claim 8, wherein the processor is configured to communicate with at least one of: an external server and an external data processing device to configure the each robotic shell.

11. The robot of claim 8, wherein the processor is configured to execute instructions to customize the robot for the each of the specific personae in accordance with the coupling between the configured corresponding robotic shell and the base mechanism based on:
automatically executing instructions to load an operating system into at least one of: a first memory of the base mechanism and a second memory of the configured corresponding robotic shell to be executed on a corresponding at least one of: a first processor of the base mechanism and a second processor of the configured corresponding robotic shell, and
automatically wrapping the loaded operating system with a wrapper specific to the each of the specific personae to customize the robot for the each of the specific personae,
wherein the processor is capable of being both the first processor and the second processor.

12. The robot of claim 8, wherein the processor is further configured to execute instructions to communicate with at least one of: an external server and an external data processing device communicatively coupled to the resulting robot to update the specific set of functionalities associated with the each of the specific personae.

13. The robot of claim 8, further comprising at least one sensor,
wherein the processor is further configured to execute instructions to communicate with a server communicatively coupled to the resulting robot to enhance at least one of: predictive and operative capabilities thereof based on the server executing at least one machine learning algorithm that considers data from the at least one sensor as input thereto and is trained thereby.

14. A system comprising:
a base mechanism comprising circuitry associated with core functionalities relevant to a robot; and
a data processing device configured to configure each robotic shell of a plurality of robotic shells with data related to a specific set of functionalities associated with a specific persona,
wherein the robot is automatically customizable for each of the specific personae associated with the configured plurality of robotic shells based on removable coupling of the configured corresponding robotic shell to the base mechanism such that the resulting robot is capable of performing the specific set of functionalities associated with the each of the specific personae through a processor associated with at least one of: the base mechanism and the configured corresponding robotic shell.

15. The system of claim 14, wherein the configured corresponding robotic shell is capable of encapsulating the base mechanism following the coupling therebetween.

16. The system of claim 14, wherein the processor is configured to execute instructions to customize the robot for the each of the specific personae in accordance with the coupling between the configured corresponding robotic shell and the base mechanism based on:
automatically executing instructions to load an operating system into at least one of: a first memory of the base mechanism and a second memory of the configured corresponding robotic shell to be executed on a corresponding at least one of: a first processor of the base mechanism and a second processor of the configured corresponding robotic shell, and
automatically wrapping the loaded operating system with a wrapper specific to the each of the specific personae to customize the robot for the each of the specific personae,
wherein the processor is capable of being both the first processor and the second processor.

17. The system of claim 14, wherein the processor is further configured to execute instructions to communicate with the data processing device to update the specific set of functionalities associated with the each of the specific personae.

18. The system of claim 14, further comprising at least one sensor of the at least one of: the base mechanism and the configured corresponding robotic shell,
wherein the processor is further configured to execute instructions to communicate with the data processing device to enhance at least one of: predictive and operative capabilities of the resulting robot based on the data processing device executing at least one machine learning algorithm that considers data from the at least one sensor as input thereto and is trained thereby.

19. The system of claim 14, wherein the data processing device is one of: a server and a mobile device.

20. The system of claim 14, further comprising a plurality of mobile devices to interact with the resulting robot based on executing an appropriate application thereon.
